(19) United States
(12) Patent Application Publication
(10) Pub. No.: US 2010/0024330 A1
(43) Pub. Date: Feb. 4, 2010

(54) MULTI-UNIT DWELLING SYSTEM AND BUILDING

(76) Inventor: Donald E. Sodaro, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/202,172

(22) Filed: Aug. 29, 2008

Related U.S. Application Data
(60) Provisional application No. 61/085,607, filed on Aug. 1, 2008.

(51) Int. Cl. E04H 3/02

(52) U.S. Cl. 52/234

(57) ABSTRACT

A multi-unit building design has a system of contiguous dwelling units arranged to occupy a single story at a high density. Each unit includes a usable area defined by an area including a bed, a chair, a television area, and a writing surface. There is a non-usable area that includes a toilet and a shower stall. The usable area relative to the overall occupied area is at least greater than about 75 percent, and as high as about 85 percent of the overall occupied area.

### RELATED APPLICATION

This application claims the benefit of and priority to U.S. Provisional Application Ser. No. 61/085,607, filed Aug. 1, 2008, and is related to U.S. Utility patent application Ser. No. 12/202,148, filed Aug. 29, 2008, the contents of both of which are incorporated by reference herein in their entirety.

### BACKGROUND

This disclosure is generally related to multi-room hotel, hostel, and motel designs. More particularly, this disclosure concerns a building that accommodates multiple dwelling rooms in multiple stories or a single story.

As environmental issues and the need for operational efficiency increase, it is important to develop dwelling units that meet these issues and needs. This disclosure concerns the ability to provide a building for a hotel or the like having a relatively high density of dwelling units which can be operated efficiently and which make the hotel or like operation efficient.

### SUMMARY

There is a need for hotels or other multi-unit dwelling buildings that are relatively high density to be economical to land and infrastructure costs. The hotel system and layout reduces the unusable space of each unit, and at the same time retains a good deal of comfort for guests.

### DRAWINGS

This disclosure can be better understood with reference to the drawing figures, in which:

FIG. 1A is a plan view of two dwelling units illustrating usable area in accordance with the disclosure.

FIG. 1B is a plan view of two dwelling units illustrating usable area in a first prior art format.

FIG. 1C is a plan view of two dwelling units illustrating usable area in detail in a second prior art format.

FIG. 2A is a plan view of two dwelling units illustrating the layout plan in detail in accordance with the disclosure.

FIG. 2B is a plan view of two dwelling units illustrating usable area in detail in a first prior art format.

FIG. 2C is a plan view of two dwelling units illustrating usable area in detail in a second prior art format.

FIG. 3A is a general layout of the building showing the assemblage of dwelling units on a first floor of the building.

FIG. 3B is a general layout of the building showing other features of the units and the floor plan of the building.

FIG. 4 is a general perspective view of the outside of the hotel building.

### DETAILED DESCRIPTION

The disclosure provides for a multi-unit dwelling building having a predetermined floor plan arrangement. The building comprises a plurality of dwelling units, each unit generally being arranged to occupy a generally rectangular area.

There are a series of units aligned in adjacency in a row along an external passageway. An access door is provided to each unit from the passageway.

A predetermined number of units have a predetermined area occupied by each unit. Each unit includes a usable area defined by an area including a bed, a chair, a television area, and a writing surface. There is an area defined as non-usable, such non-usable area includes a toilet and a shower stall. The non-usable area is essentially the non-living area. The usable area relative to the overall occupied area is at least greater than about 75 percent of the overall occupied area. In some cases the usable area relative to the overall occupied area is at least greater than about 80 percent of the overall occupied area, and even about 85 percent of the overall occupied area.

In one form, the usable area is in a range of about 200 square feet to 350 square feet, and the usable area is respectively in the range of about 180 square feet to about 300 square feet relative to the overall occupied area. As such the usable area is at least greater than about 75 percent of the overall occupied area.

In another form the usable area is in a range of about 240 square feet to 300 square feet, and the usable area is respectively in the range of about 200 square feet to about 250 square feet relative to the overall occupied area. As such the usable area is at least greater than about 80 percent of the overall occupied area.

In yet another form, the usable area includes a washing basin, and the shower stall is essentially square in plan, and the occupied area excludes an internal passageway from the access door opening into the occupied area. The usable area starts directly from the doorway. The washing basin is located between the non-usable area and the access door opening into the unit from the external passageway. A sliding door is for selectively separating the usable area from the non-usable area.

In other aspects the units include a bay window for the usable area. There is a closet for the usable area. There is provision for central HVAC to the units, wherein the unit does not contain a local HVAC system for each unit, and each unit includes ports for ducting for circulating the HVAC between each unit and a central HVAC processing system. There can be limited cooking and eating facilities in each unit, such facilities including a microwave device and a kettle.

As part of the system there can be card-activated electronically controlled access to the door of each unit and to control the electricity to each unit. An electronic security system can sense whether doors to respective units are open or closed, and can signal a central control area geographically remote from the building as to the state or condition of the doors of the units. The electronic security system can determine whether doors to common areas in the building are open or closed, and can signal a central control area geographically remote from the building as to the state or condition of the doors of the common areas.

The electronic security system can provide access to common areas, and selectively a main door to provide access to the building. Guests to the building can be provided with a respective key card for electronically accessing the common areas, the main door to the building and a dedicated unit assigned to the guest on checking in to the building.

The checking in to the building is effected by an electronic kiosk. The guest inputs requisite input data to the kiosk and the kiosk records the check-in and selectively the checking out of the guest. The guest thereafter is able to access the designated doors and facilities through a security card appropriately validated by the kiosk.

In some situations, the building excludes a designated common room for dining or for meeting. The lobby area with limited seating is the single common area for a limited meeting, and this is not set up for a private closed meeting.

The access to the building leads to the electronic check-in kiosk, and from there directly or indirectly to the external passageways to the units or an elevator bank to other floors or a stairwell between floors.

Each unit is generally being arranged to occupy a generally rectangular area. A series of units are aligned in adjacency in a row along an external passageway. There is an access door to each unit from the external passageway, and a predetermined number of units have a predetermined occupied area by each unit.

A bay window is provided for the usable area. This window is part of an extension formation to a generally rectangular structure or is an alcove add-on to the generally rectangular room, the add-on projecting from the rectangular unit. In a different sense, the windows extend on the outside facing wall or walls in different directions, for instance, two directions along these wall or walls. In this manner an increased sense of openness is provided to the unit. The windows forming the alcove or bay appear essentially contiguous to each other.

The window portions from respective adjacent units which essentially face each other in part are spaced from each other by a solid wall, the angle of the two windows for each unit have different angles between them, and can for instance be about 135 degrees as measured from the inside.

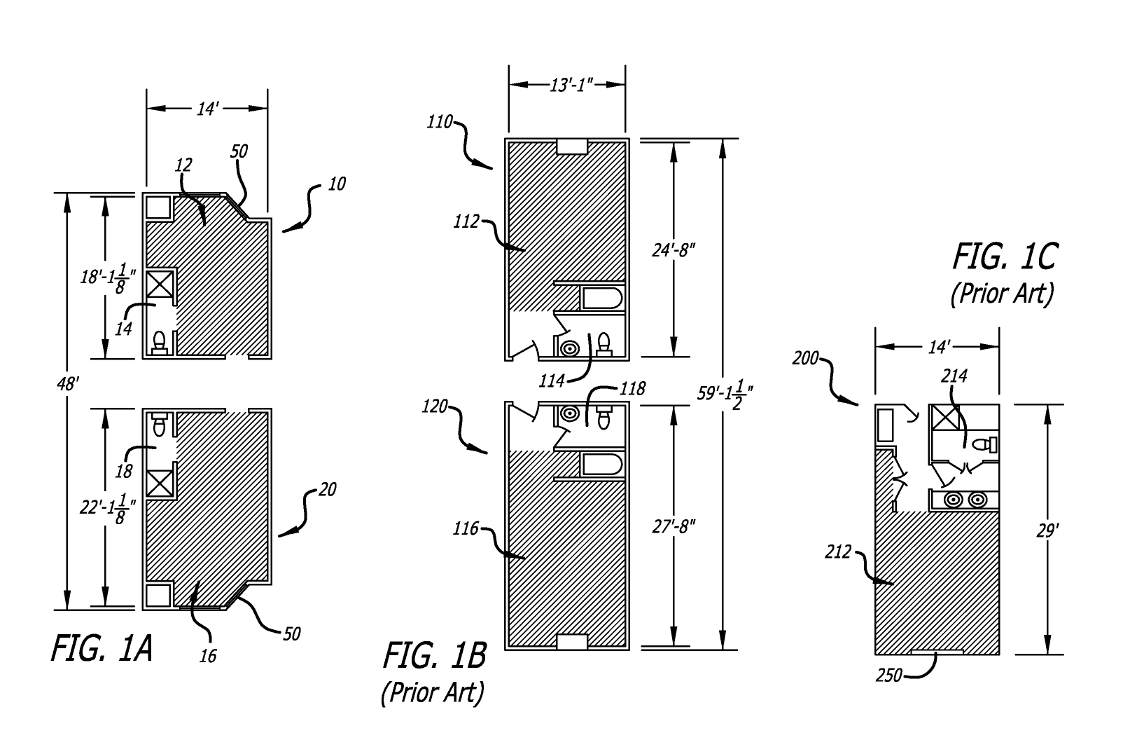

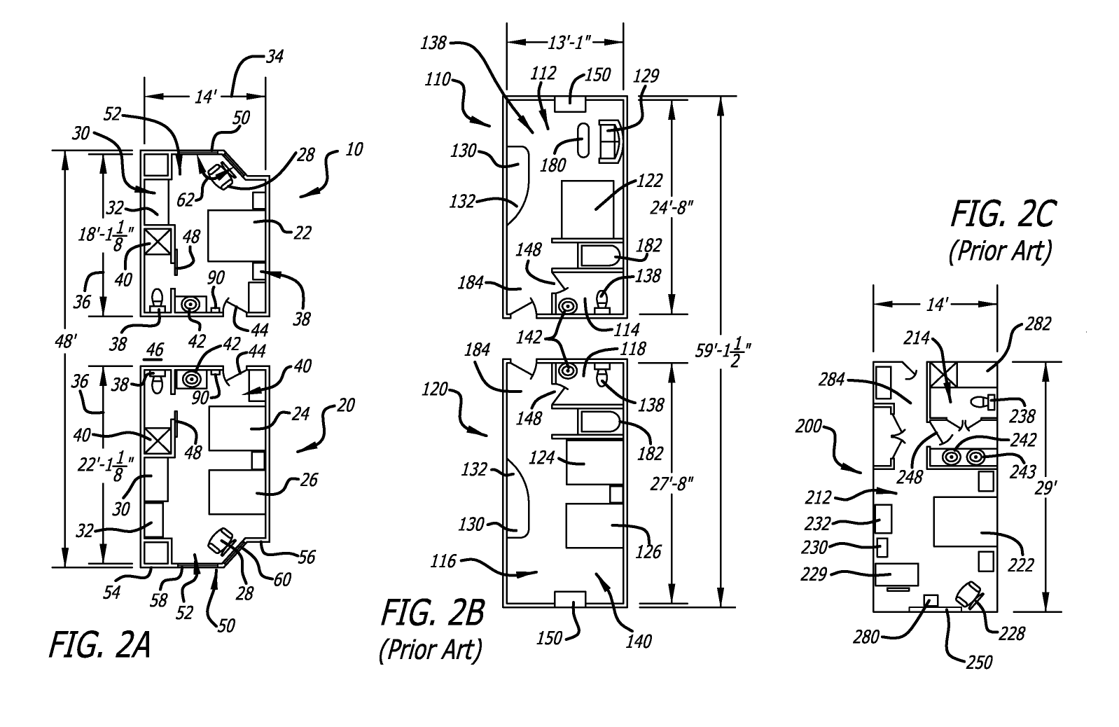

The disclosure plans of FIGS. 1A and 2A show dwelling units 10 and 20 formed from essentially rectangles as seen in the plan. Each of the units 10 and 20 includes one bedroom 12 or 16 and a bathroom area 14 or 18 adjacent to the usable living space 12 or 16. It can be seen that there are bay windows 20 fronting every unit 10 and 20.

The units have an overall occupied area of 242 total square feet for a room having a king bed 22, and 299 square feet for a room having two queen beds 24 and 26. Each unit 10 and 20 includes a usable area 12 or 16, respectively, defined by an area including a bed 22 or 24 and 26, respectively, a chair 28, a television area 30, and a writing surface 32. There is closet in the usable area. The usable area, 12 and 16, respectively, is in a range of about 199 square feet to 254 square feet respectively. The generally rectangular area includes a width 34 and a length 36.

There is an area 14 and 18 defined as non-usable and this non-usable area includes a toilet 38 and a shower stall 40 which is essentially square in plan. There is no bathtub in the non-usable area 14 and 18.

The usable area 12 and 16 relative to the occupied area 38 and 40 is at least greater than about 82 percent of the overall occupied area and about 85 percent, respectively, of the overall occupied area 38 and 40 respectively.

The usable area 12 and 16 includes a washing basin 42, and the occupied area 10 and 20 excludes an internal passageway to the occupied area 10 and 20. The washing basin 42 is located between the non-usable area 14 and 18 and the access door opening 44 into the units 20 and 30 from the external passageway 46. A sliding door 48 separates the usable area 12 and 16 from the non-usable area 14 and 18, respectively.

The bay window 50 is in an area that is part of an extension formation or area 52 to a generally rectangular area or is an alcove add-on 52 to the generally rectangular room 12 and 16, respectively. The add-on 52 projects from the rectangular area. The window 50 extends between the outside facing wall 54 and the outside wall 56 in two directions. The window portions 58 and 60 form the alcove 52 or bay window appear essentially contiguous to each other.

The window portions 58 and 60 from respective adjacent units 10 and 10 respectively, and 20 and 20 respectively, essentially face each other in part and are spaced from each other by solid walls 60 of each adjacent unit 10. The angle of the two window portions 58 and 60 for each respective unit 10 and 10 and 20 and 20 have an angle 62 of about 135 degrees as measured from the inside of the units.

In each unit 10 and 20, there are outlets 90 for HVAC ducts which are connected with a central HVAC unit 92.

The prior art plans of FIGS. 1B and 2B show dwelling units 110 and 120 formed from essentially rectangles as seen in the plan. Each of the units includes one bedroom 112 and 116 and a bathroom area 114 or 118 adjacent to the usable living space 112 and 116.

The units 110 have an overall occupied area of 322 total square feet for a room 120 having a king bed 122, and 362 square feet for a room 120 having two queen beds 124 and 126. Each unit 110 and 120 includes a usable area 112 and 116, respectively, defined by an area including a bed 122 or 124 and 126, respectively, a couch 129, a table 180, television area 130, and a writing surface 132. The usable area 112 and 116, respectively, is in a range of 220 square feet to 262 square feet, such that the usable area is 68 to 72 percent respectively of the overall occupied area 138 and 140, respectively.

There is an area 114 and 118, respectively, defined as non-usable and this non-usable area 114 and 118 includes a toilet 138 and a bathtub 182 in the non-usable area. A washbasin 142 is in the non-usable area 114 and 118, respectively.

The occupied usable area 112 and 116, respectively, includes an internal passageway 184 to the occupied area 112 and 116. A swing door 148 separates the usable area 112 and 116 from the non-usable area 114 and 118, respectively. There is only a single linear window 150 in the room.

The prior art plans of FIGS. 1C and 2C show a dwelling unit 200, formed from essentially a rectangle as seen in the plan. The unit 200 includes one bedroom 212 and a bathroom area 214 adjacent to the usable living space

The units 200 have an overall occupied area of 406 total square feet for a room having a king bed 222. The unit 200 includes a usable area 212 defined by an area of 244 square feet and includes the bed 222, a chair 228, a couch 229, a table 280, and television area 230, and a writing surface 232. The usable area is 59 percent of the overall occupied area.

There is an area 214 defined as non-usable and this non-usable area 214 includes a toilet 238 and a bathtub 282 in the non-usable area. The washbasins 242 and 343 are in the non-usable area 214.

The occupied usable area 212 includes an internal passageway 284 to the occupied area 212. A swing door 248 separates the usable area 212 from the non-usable area 214. There is only a single linear window 250 in the room.

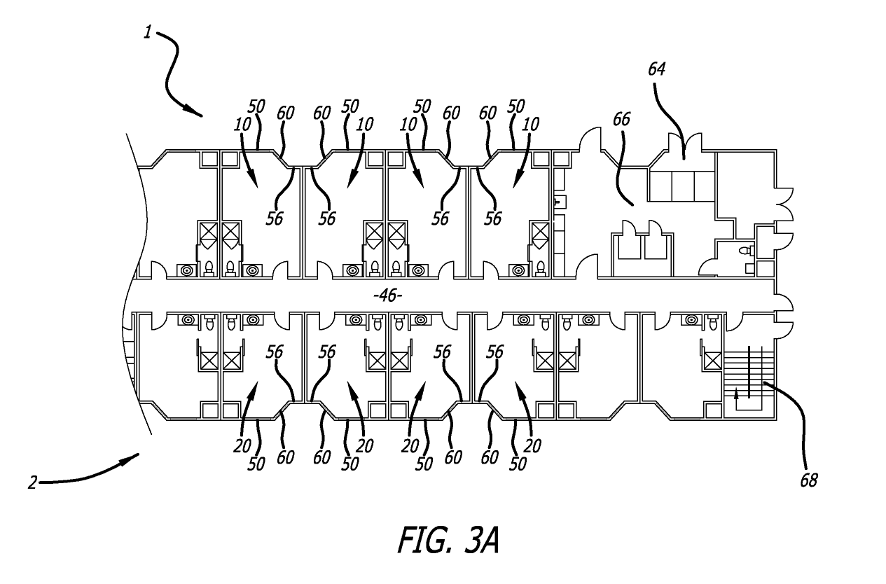

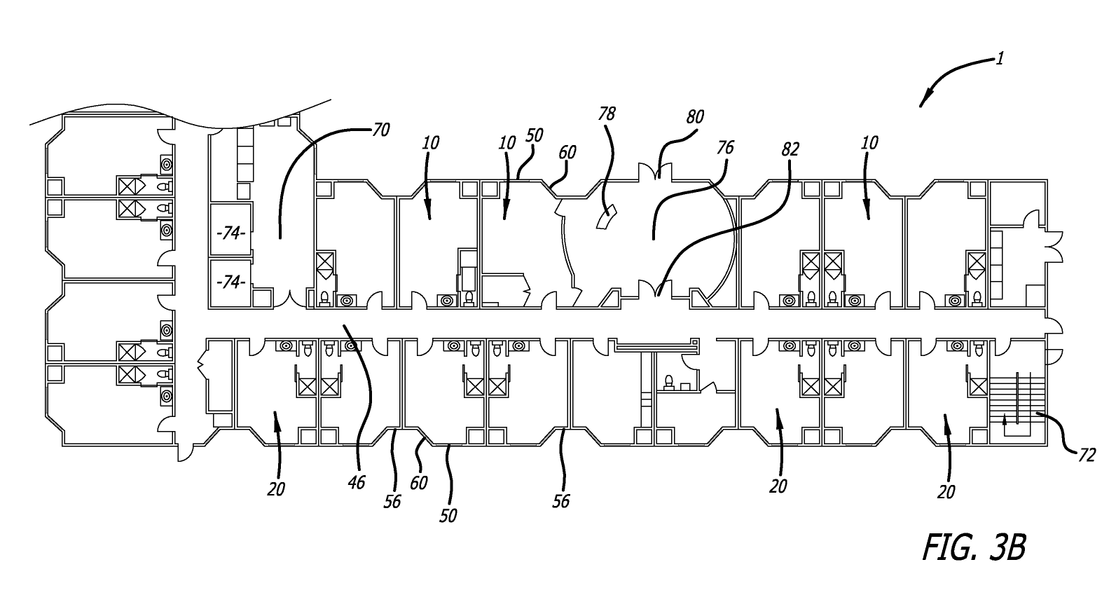

FIG. 3A of the disclosure shows a partial floor plan of a multi-unit building 1 on a generally rectangular area 2. The floor plan shown in FIG. 3A provides multiple one-room or one-bedroom units 10 and 20. This part of the floor plan also shows the utility area 64 where there is a laundry facility 66 and there is a stairwell 68.

The building 1 is arranged with one or a plurality of external passageways 46. Each passageway 46 is formed with a connected arrangement with an elevator central lobby 70 for each floor or for a stairwell 68 or 72 or elevator 74 between floors or levels.

Each dwelling unit 10 and 20 is formed from essentially rectangles as seen in the plan. FIGS. 1A and 1B show a more detailed view of the units in the building 1.

FIG. 3B of the disclosure shows a partial floor plan of a ground or entrance floor and lobby area 76. There is a kiosk 78 for checking in and for checking out of the hotel which is provided in the building 1. At the kiosk 78, a security card is provided on check-in and this card provides for access to the relevant designated rooms 10 or 20 or other units of the hotel. This part of the floor plan also shows the elevator bank 70 and a stairwell 72. There is a main door 80 that also provides the access to the lobby 76. There is a second door 82 providing access to the passageways 46 and units 10 and 20 and elevators 70 and different facilities of the hotel. The electronic keycard can be used to provide passage through the doorway 82.

This arrangement of dwelling units of the disclosure provides substantial livability in a relatively small space and also provides an enhanced arrangement of dwelling units. It should be noted that this construction can be provided in a stacked, vertical arrangement to form a multi-story building having such dwelling units. It will be appreciated by those skilled in the art that the entranceways to such multi-story dwelling units will be provided by stairways or elevators as necessary.

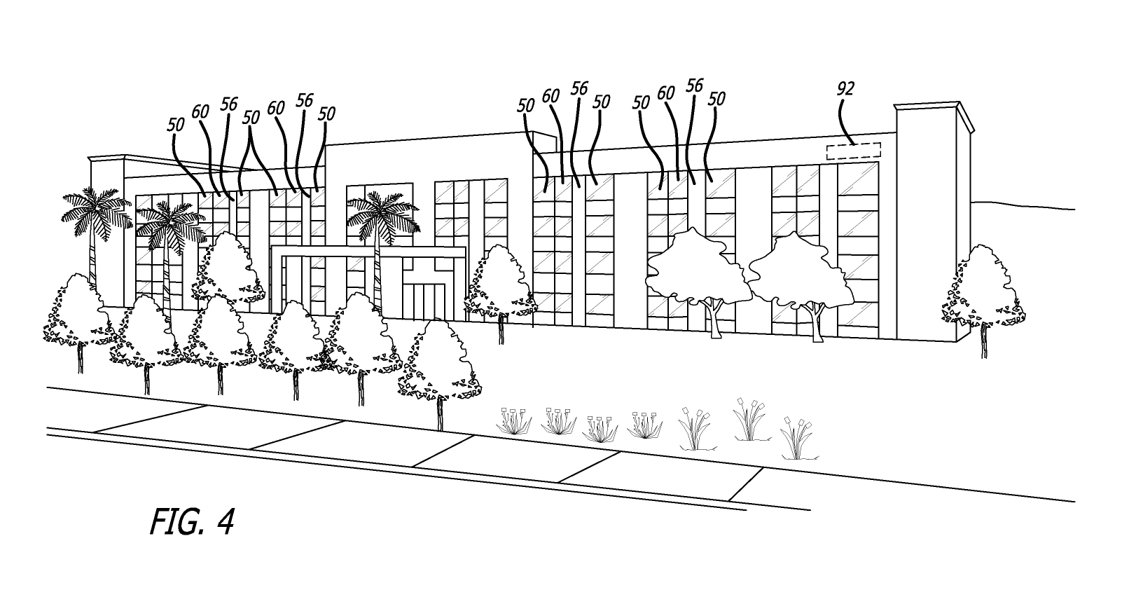

The building as shown in FIG. 4 can comprise a plurality of floors with each floor of the building being formed from the multi-room dwelling units. The layout of each unit is substantially the same.

The predetermined arrangement of rows and the units are disposed in a relationship to provide a substantially maximized ratio of dwelling units to useable space available in the generally rectangular area. Each dwelling unit includes a generally rectangular area.

From the outside appearance of the building there is the outer wall of each unit which is a section between the kink or bay window between two wall sections to either side. When the kink formation is used for the bay window, the sidewall of the unit on the non-kinked side is longer than the sidewall of the opposite wall.

The bay window area provides a convenient area for location of a chair in the unit. The window extends in height in one form ideally from the floor to the ceiling. All of this structure enhances the comfort and spacious feeling of the room for the guest, and yet retains the overall square footage at a lesser amount than would otherwise be expected, to give essentially the same sense of satisfaction to the guest.

The dwelling system and building allows for accommodating the multi-unit living requirements of singles, couples and families at a relatively high density, providing the occupants with the look and feel of a comfortable environment. Specifically there are adequate windows for every unit. This system can reduce construction costs and operational management costs.

While there can be a building with multiple one-room units, there can be a configuration which includes multiple bedrooms in a unit. In some situations there are inter-leading doors which are provided, and thus the configuration should not be considered restricted to this arrangement.

Clearly, the number of units can be varied simply by altering the length of the building. There can be a single story multi-unit dwelling or further density can be achieved by repeating the layout in a multi-story configuration.

The unit layout and hotel is part of a centralized multiple hotel management system, or a “smart” hotel system. This centralized system, or “CenCom” centralizes functions, which include but are not limited to, registration, reservations, check-in, property management, and accounting. Through such a centralized system, a small group of trained employees at a remote central office are able to manage all the major functions for all the hotels. Local management at the individual hotels may then focus their attention on the more specific details of operating their individual hotels. The net result of this is major improvements in operational efficiencies and guest satisfaction.

A centralized multiple hotel management system comprises at least one of a centralized guest registration function, a centralized reservation function, a centralized guest check-in/check-out function, a centralized accounting function, and a centralized property management system function.

A multi-location management system comprises a plurality of locations connected to a remote control center. Task function data are transmitted from the individual locations to the remote control center, wherein the task function data is processed at the remote control center.

In one exemplary implementation, a multi-location management system for hospitality locations, including hotels, comprises a plurality of hospitality locations connected to a remote control center, the remote control center being located physically separate from the plurality of hospitality locations. The remote control center provides remotely controllable and reportable security for the plurality of hospitality locations. The system also includes task function data transmitted from at least one of the plurality of locations to the remote control center, wherein the task function data is processed at the remote control center.

In another exemplary implementation, a centralized multiple hotel management system comprises a plurality of hospitality locations connected to a remote control center, the remote control center being located physically separate from the plurality of hospitality locations. The remote control center also provides remotely controllable and reportable security for the plurality of hospitality locations. The system also includes a centralized guest registration function, wherein data from a guest registration process at a hotel is transmitted to the remote control center and processed at the remote control center. There is also a centralized reservation function, wherein data from a room reservation process is transmitted to the remote control center and processed at the remote control center, the data from the room reservation process including a personal identification number (PIN) which is assigned by a computer terminal to a guest. Also included is a centralized guest check-in/check-out function, wherein data from a guest check-in or guest check-out process at a hotel is transmitted to the remote control center and processed at the remote control center. The guest check-in or guest check-out process data is sent from a self-service terminal located at the hotel, where the self-service terminal performs the guest check-in or guest check-out process if the self-service terminal records entry of a PIN equal to the assigned PIN. The PIN is usable for multiple lodging establishments. The system also includes a centralized accounting function, wherein data from an accounting process at a hotel is transmitted to the remote control center and processed at the remote control center. There is also a centralized property management system function, wherein data from a hotel operation process at the hotel is transmitted to the remote control center and processed at the remote control center.

In one aspect, CenCom includes a centralized guest registration function. Every guest will only have to register once to be registered at every participating individual property.

The centralized guest registration function of CenCom helps eliminate serious guest annoyance and large costs to the hotel, by allowing a small group of employees at a central office to effectively manage the front desk registration process for all the properties and further by eliminating the need for repeat registrations from returning guests. The individual hotel operational cost inefficiencies associated with the fluctuations between idleness and activity at a front desk are reduced because a plurality of hotels and their front desks allow the employees at the central office to remain actively busy.

A guest may enroll (register) in one of three ways: on the Internet, at the kiosk on the property, or by phone to CenCom. In one embodiment, the guest may be required to enroll prior to taking any other action, but the guest will only enroll (register) once. After the guest is enrolled, the guest is “in the system” forever. If the guest is a “bad actor” or has created problems at a hotel, that guest's enrollment file may be marked by CenCom personnel and blocked from the system.

CenCom can operate widely with participating hotels located in different time zones, for even greater efficiencies. Commonly, the peak hours of front desk activity occur between 6 PM and 9 PM, when the majority of guests check in. In one example, while many people are checking in on the East Coast of the United States, things will be quiet on the West Coast and just building up in the Midwest. This system in effect allows CenCom to “move” the front desk staff across the country to where there is more guest activity buildup, effectively focusing resources to where it is most needed. As more and more guests use the Internet to register on CenCom, staff involvement in the registration process will diminish appreciably.

In another aspect, CenCom includes a centralized reservation function. Once a guest has registered, they may then make reservations through CenCom by methods such as over the phone, by facsimile, or through the Internet. These methods may be multilingual in order to accommodate guests from all nationalities. Pricing policies may be implemented to encourage guests to use a certain type of reservation method, such as using the Internet. Reservations may also be performed even if the guest is already located at the hotel.

A guest who is enrolled (registered) may make a reservation, even if it is for the same day. The reservation may come in from several sources, including but not limited to, the self-service terminal or kiosk, the Internet, a CenCom operator talking to the guest over the phone, from the enrollment or registration process, or from the “guest problem” flow chart.

The registration process includes taking the request, verifying the password, searching the current data file to ascertain if rooms are available to fulfill the requested reservation, calculating the total charges and, if confirmed by the guest, making the reservation and confirming it. The guest pays for the reservation via credit card at the time the reservation is confirmed.

The system may determine if a guest's requested reservation is to be accepted as requested or what alternatives are available to them.

A guest can modify or cancel their reservation. The guest may do this through various channels, including through the Internet, by calling CenCom, and at the self-service terminal or kiosk on any property. Depending on the management policy, the guest may or may not get a full or partial refund.

CenCom includes a centralized check-in/check-out function. In one embodiment, a guest may check-in at an automated kiosk which is connected to CenCom. This connection may be through the Internet.

A self-service transaction method is disclosed comprising the steps of establishing a personal identification number (PIN) assigned by a self-service terminal to a user at a location, recording a request of the user, and performing the request by the self-service terminal if the self-service terminal records entry of a PIN equal to the assigned PIN.

A self-service transaction method facilitates reservation at a lodging establishment is disclosed. A personal identification number (PIN) is assigned by a computer terminal to a user, the user being at a location remote from the lodging establishment, recording a request of the user at a self-service terminal at the lodging establishment, the request being at least one of a check-in and check-out request, and performing the request by the self-service terminal if the self-service terminal records entry of a PIN equal to the assigned PIN, the PIN being usable for multiple lodging establishments.

A guest may check in at a self-service terminal or kiosk. The guest will first be prompted to touch the screen to begin. There are then three different ways in which the guest verifies their identity and retrieves their reservation: the guest enters their username and password, the guest swipes their credit card and is then prompted to enter in their zip code for authorization, or the guest scans the bar code that is printed on the verification e-mail that they received when making the reservation. The guest will then confirm the reservation (room type and length of stay) and will be issued a room key and receipt.

A room may be assigned to a guest when the guest checks in. First, the rooms that are available of the type requested are determined by subtracting the rooms of that same type already assigned to guests and the rooms that are out of service. Then it is determined if, of the rooms available, there are any that are clean and available. Once it is determined what rooms of the type requested are available, the system assigns a room based upon an algorithm that takes into consideration any guest preferences and the number of times a particular room has been rented.

There is a process for validating a guest's password and then permitting him to enter the system to perform whatever function or request he wishes to perform.

There are several functions or requests that a guest may perform at the self-service terminal or kiosk. Functions or requests include, but are not limited to, selecting a language, check-in, making a reservation, obtaining a new key, extending their stay, check-out and getting a complete statement of their stay if so desired (optional to guest), and enrolling (registering) in the system if he is a new guest. The enrollment (registration) process only needs to done once.

A guest may be permitted, after verification of password, to leave early, extend a stay, change rooms, or get a new key. The guest may do this at the kiosk, on the internet or by telephone to CenCom personnel.

In one example, when a guest arrives at the hotel, the guest will find that there is no “front desk” but only a concierge desk and several kiosks with phones attached. The experienced guest will go to the “express check-in” kiosk, enter his ID number, swipe his credit card or drivers' license, or scan his reservation bar code. A receipt will be printed with his room number on it and a magnetic key card will be printed. The guest then can open the door to the corridors and elevator and go to their assigned room.

Another guest, not familiar with the system, would merely pick up a phone at the kiosk and personnel at CenCom would check that person in. Both the kiosk and the CenCom personnel may be able to converse with the guest in his preferred language. Management staff at the property would also be available to provide whatever additional assistance the guest may need.

A guest may want a stay of two or more days but the room type they have selected is available for some but not all of the days requested. The guest may be given the option of taking the requested room for the days it is available and moving to another room when the room they are in is no longer available.

In another aspect of the present disclosure, CenCom includes a centralized accounting function. The accounting function may include the handling of all revenue, the collection of funds as well as the payroll and the accounts payable, the preparation of all of the operating financial reports, and the management of cash flow and distributions to owners. Purchasing can also be centralized through CenCom or at the property owners choice, handled locally.

Databases at CenCom may be designed in such a way to generate all of the operating reports necessary to fulfill the “back office function” such as revenue, bed taxes, occupancy rates, etc. The payroll may come in over the Internet from time clocks on the property and all bills may go to each property, be approved, and then forwarded to CenCom for payment and proper accounting. In this way CenCom may prepare all of the necessary financial reporting for every property.

In one example, a guest will pay for the reservation at the time it is made through CenCom by the use of his credit or debit card. There will be no cash transactions or payments made at the hotel. All of the operational accounting including revenue and revenue management, payroll and payables will be done through CenCom. No accounting will be done at the property. All operational accounting reports and operational taxes returns will be prepared and filed through CenCom.

Rate calculations may be performed for a room. Rates may vary, including but not limited to, from hotel to hotel, by room type, the day of the week, with various exceptions such as special events, whether the reservation was made on the Internet, whether it was made many days in advance, and whether the guest is a member of a group that gets special rate considerations. All of this can be considered on a day by day basis in order to determine the total charge for the room.

In another aspect CenCom includes a centralized property management system function. The property management system function monitors many aspects of the individual hotel operations and alerts the associated manager of issues that need attention. Security cameras may be located at all critical areas of the hotel and monitored 24/7 by CenCom. Calls from the room to the onsite manager may be routed through CenCom for the appropriate action by trained personnel. Room, hall and exterior lighting as well as heating and air conditioning in the common areas and guest rooms may also be monitored through CenCom.

The property management system function may also gather and manage information such as energy usage, repair requests, and temperature control from the guestrooms. This information may be automatically processed by the property management system to generate historical trends and reports for use by housekeeping, engineering, security and other hotel staff.

Furthermore, the property management system function may include a centralized lock control system. The opening and closing of all internal and external doors may be monitored by CenCom and may also be monitored on closed circuit televisions. The centralized lock control system may detect doors that are left ajar or if there are any forced entries, and alert the affected hotel as well as the central office. A centralized lock control system would simplify guest check-in procedures as well as key card cancellations upon check-out. If needed, late check-out key card extensions may also be provided remotely. Monitoring all the locks would provide greater guestroom security as well as real-time tracking of hotel employees and detailed, unlimited-access audit trails. There may also be automatic time synchronization of all the locks. Furthermore, the centralized lock control system would provide greater efficiency to individual hotel operations by eliminating incorrect key-card issuances and providing centralized staff and guest card cancellations.

The system may pick up the fact that the guest room door has been opened by the guest, a member of the staff, or an unauthorized person. If the room is rented and the guest has checked in and the door is opened, the system will assume it is the guest that opened the door; however, there is no way to know for sure. If the door closes and motion is detected in the room the system will assume it is the guest. If however, the user is a member of the staff, they would put their ID card in a card reader so that CenCom would now know which staff member is in the room. On the other hand, if the room is not rented and the door opens, it would be likely that this would be a staff member. In this case they would put their ID card in the reader. There may also be the possibility that the staff member forgets to enter their ID car in the reader, or it is an unauthorized person. Should the staff member forget to place their ID card in the reader, CenCom assumes it is an unauthorized person in the room and notifies the manager.

In addition to identifying who is in the room and notifying the manager that corrective action may be necessary, two other things would also be accomplished. It would be known if the room is occupied and for security reasons, it would be known if the door remains open or not. If the door remains open beyond a prescribed length of time the manager may be notified. Therefore, CenCom has knowledge of the status of each room essentially at all times. This is helpful for housekeeping purposes and essential for security. This same system may also be applied to work for all exterior doors.

A card reader may be used in each room in conjunction with an employee identification card to tell CenCom which employee is in the room. The housekeeper enters his/her card in the reader and leaves it there while cleaning the room. CenCom makes a note of who it is and when the card was inserted. It notes when the card was withdrawn and calculate the elapsed time. If it is a housekeeper's card and the room had been rented the night before it is assumed that the housekeeper was cleaning the room. CenCom lists the room as “cleaned but not inspected”. If the room has been marked as ‘cleaned but not inspected’ and the executive housekeeper inserts his/her card and withdraws it CenCom marks the room “ready to rent”. An entry into the room by either the maintenance department or the manager is also noted by CenCom. By knowing who is in the room the necessary energy controls may be implemented.

Centralization of the multiple function of multiple hotels may be achieved through the use of the high speed internet.

A comprehensive and integrated system is disclosed to centrally control essentially most major functions of the hotel thus leaving the management of the hotel free to focus their attention on managing. It places the major administrative functions of the hotels in the hands of highly trained and well paid staff people backed up by supervisors, managers and the executive staff. The net result of this is significant improvements in operational efficiencies and guest satisfaction.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A multi-unit dwelling building having a predetermined floor plan arrangement, the building comprising a plurality of multi-room dwelling units, the unit generally being a series of units aligned in adjacency in a row along an external passageway, and including an access door to each unit from the passageway, a predetermined number of units having a predetermined occupied area by each unit, and wherein each unit includes a usable area defined by an area including a bed, a chair, a television area, and a writing surface, and an area defined as non-usable, such non-usable area including a toilet and a shower stall, and wherein the usable area relative to the overall occupied area is at least greater than about 75 percent of the overall occupied area.

2. A multi-unit dwelling building according to claim 1, wherein the usable area relative to the overall occupied area is at least greater than about 80 percent of the overall occupied area.

3. A multi-unit dwelling building according to claim 1, wherein the usable area relative to the non-usable area is about 85 percent of the overall occupied area.

4. A multi-unit dwelling building having a predetermined floor plan arrangement, the building comprising a plurality of multi-room dwelling units, each unit generally being arranged to occupy a generally rectangular area, selectively with one wall being angulated, and wherein a series of units are aligned in adjacency in a row along an external passageway, and including an access door to each unit from the external passageway, a predetermined number of units having a predetermined occupied area by each unit, and wherein each unit includes a usable area defined by an area including a bed, a chair, a television area, and a writing surface, and an area defined as non-usable, such non-usable area including a toilet and a shower stall, and wherein the usable area includes a washing basin, and wherein the shower stall is essentially square in plan, and wherein the occupied area excludes an internal passageway to the occupied area.

5. A multi-unit dwelling building according to claim 4, wherein the usable area is in a range of about 240 square feet to 300 square feet, and the useable area is in the range of about 200 square feet to about 250 square feet relative to the non-usable area, such that the usable area is at least greater than about 80 percent of the overall occupied area.

6. A multi-unit dwelling building according to claim 1, wherein the usable area includes a washing basin, and wherein the washing basin is located between the non-usable and the access door opening into the unit from the external passageway.

7. A multi-unit dwelling building according to claim 1, including a sliding door for selectively separating the usable area from the non-usable area.

8. A multi-unit dwelling building according to claim 1, including a bay window for the usable area.

9. A multi-unit dwelling building according to claim 1, including a closet for the usable area.

10. A multi-unit dwelling building according to claim 1, including provision for central HVAC to the units, wherein the unit does not contain a local HVAC system for each unit and each unit includes ports for ducting for circulating the HVAC between each unit and a central HVAC processing system.

11. A multi-unit dwelling building according to claim 1, including limited cooking and eating facilities in each unit, such facilities including a microwave device and a kettle.

12. A multi-unit dwelling building according to claim 1, including card activated electronically controlled access to the door of each unit and control of the electricity to each unit.

13. A multi-unit dwelling building according to claim 1, including an electronic security system for determining whether doors to respective units are open or closed, and for signaling a central control area geographically remote from the building as to the state of the doors of the units.

14. A multi-unit dwelling building according to claim 1, including an electronic security system for determining whether doors to common areas in the building are open or closed, and for signaling a central control area geographically remote from the building as to the state of the doors of the common areas.

15. A multi-unit dwelling building according to claim 1, including an electronic security system for providing access to common areas, and selectively a main door to access the building, and wherein guests to the building are provided with a respective key card for electronically accessing the common areas, the main door to the building and a dedicated unit assigned to the guest on checking in to the building.

16. A multi-unit dwelling building according to claim 1, wherein checking in to the building is effected by an electronic kiosk, the guest inputting requisite input data to the kiosk and the kiosk recording the check-in and selectively the check-out of the guest, and the guest thereafter being able to access the designated doors and facilities through a card appropriately validated by the kiosk.

17. A multi-unit dwelling building according to claim 1, wherein the building excludes a designated common room for dining or for meeting, the access to the building leading to the electronic check-in kiosk, and from there directly or indirectly to the external passageways to the units.

18. A multi-unit dwelling building having a predetermined floor plan arrangement, the building comprising a plurality of multi-room dwelling units, a series of units being aligned in adjacency in a row along an external passageway, and including an access door to each unit from the external passageway, a predetermined number of units having a predetermined occupied area by each unit, and wherein each unit includes a usable area defined by an area including a bed, a chair, a television area, and a writing surface, and an area defined as non-usable, such non-usable area including a toilet and a shower stall, wherein the usable area includes a washing basin, and wherein the shower stall is essentially square in plan, and wherein the occupied area excludes an internal passageway to the occupied area, and wherein the washing basin is located between the non-usable and the access door opening into the unit from the external passageway, a sliding door for selectively separating the usable area from the non-usable area, a bay window for the usable area, and provision for central HVAC to the units, wherein the unit does not contain a local HVAC system for each unit, and each unit includes ports for ducting for circulating the HVAC between each unit and a central HVAC processing system.

19. A multi-unit dwelling building according to claim 18, including wherein the usable area is in a range of about 240 square feet to 300 square feet, and the usable area is in the range of about 200 square feet to about 250 square feet relative to the overall occupied area, such that the usable area is at least greater than about 80 percent of the overall occupied area.

20. A multi-unit dwelling building according to claim 18, including card activated electrically controlled access to the door of each unit and control of the electricity to each unit, an electronic security system for determining whether doors to respective units are open or closed, and for signaling a central control area geographically remote from the building on the state of the doors of the units, an electronic security system for determining whether doors to common areas in the building are open or closed, and for signaling a central control area geographically remote from the building on the state of the doors of the common areas, and an electronic kiosk wherein checking in to the building is effected by the electronic kiosk, the guest inputting requisite input data to the kiosk and the kiosk recording the check-in and selectively the check-out of the guest, and the guest thereafter being able to access the designated doors and facilities through a card appropriately validated by the kiosk.
